(19) United States
(12) Patent Application Publication
(10) Pub. No.: US 2020/0357127 A1
(43) Pub. Date: Nov. 12, 2020

(54) REGISTRATION APPARATUS, REGISTRATION METHOD, AND PROGRAM

(71) Applicant: FUJIFILM Corporation, Tokyo (JP)

(72) Inventor: Futoshi SAKURAGI, Tokyo (JP)

(73) Assignee: FUJIFILM Corporation, Tokyo (JP)

(21) Appl. No.: 16/937,603

(22) Filed: Jul. 24, 2020

Related U.S. Application Data
(63) Continuation of application No. PCT/JP2018/042897, filed on Nov. 20, 2018.

(30) Foreign Application Priority Data
Feb. 9, 2018 (JP) 2018-022470

(51) Int. Cl. G06T 7/33

(52) U.S. Cl. CPC G06T 7/33; G06T 2207/30101

(57) ABSTRACT

A tubular region acquisition unit acquires a first stent region and a second stent region from three-dimensional images. A model setting unit sets a first tubular model and a second tubular model that represent a surface shape of a stent, respectively, for the first stent region and the second stent region. A corresponding point setting unit sets a plurality of corresponding points that correspond to each other, respectively, for the first tubular model and the second tubular model. A first registration unit registers the first tubular model and the second tubular model on the basis of the corresponding points to obtain a first registration result.

### CROSS REFERENCE TO RELATED APPLICATIONS

The present application is a Continuation of PCT International Application No. PCT/JP2018/042897 filed on Nov. 20, 2018, which claims priority under 35 U.S.C. § 119(a) to Japanese Patent Application No. 2018-022470 filed on Feb. 9, 2018. Each of the above applications is hereby expressly incorporated by reference, in its entirety, into the present application.

### BACKGROUND

### Technical Field

The present disclosure relates to a registration apparatus, a registration method, and a program for registering structures included in a plurality of medical images having different imaging times.

### Related Art

In the related art, as a treatment for an aneurysm or the like, an operation of placing a stent in an artery has been performed. In such an operation, the stent is placed at a position planned in advance, but there is a possibility that the stent may be moved or deformed over time. Such movement and deformation of the stent from the planned position may resume blood flow to the aortic aneurysm occluded by the stent. Further, although a branch of a blood vessel is not blocked in a case where the stent is placed, there is a possibility that the movement and deformation of the stent may block the branch of the blood vessel.

Accordingly, it is important to determine in advance whether or not there are the above-mentioned possibilities by quantifying the amount of movement and the amount of deformation of the stent. For this reason, a method for extracting a stent region from a plurality of medical images such as computed radiography (CT) images having different imaging times and registering the extracted stents has been proposed (see JP2016-104121A). Further, a method for stacking cross sections of a blood vessel region in which a stent is placed to generate a cylindrical model and detecting a contact region between the stent and the blood vessel on the basis of the cylindrical model has been proposed (see JP2014-108313A). In addition, in order to quantify the amount of deformation, a method for performing non-rigid registration between stents in a plurality of images may also be considered.

However, in a case where the amount of deformation between the stents is large, it is difficult to register the stents by the non-rigid registration. In such a case, a method for setting corresponding points for registration with respect to the stent regions respectively extracted from the plurality of medical images to improve the accuracy of registration may be considered. In order to accurately perform the registration using the corresponding points, it is preferable to set a large amount of corresponding points. However, an operation of manually setting a plurality of corresponding points is very complicated. Further, since the corresponding points are set by an operator's subjective view point, there is a possibility that positional deviation of the set corresponding points may occur. In a case where such deviation of the corresponding points occurs, it is not possible to perform registration with high accuracy.

Further, considering that the stent has a mesh structure, a method for employing a model imitating grid points of a mesh of the stent and using the grid points in the model as corresponding points may be considered. However, the shape and size of the mesh vary depending on a stent manufacturer. For this reason, in a case where the stent model is used, it is necessary to prepare a plurality of types of models. Further, since the shape and size of the mesh are different from those of the model due to deformation of the stent depending on a state where the stent is placed, it is necessary to adjust parameters for correcting the difference. Further, in a case where a plurality of types of stents are placed in a blood vessel, a region where the stents overlap each other occurs. In such a region where the plurality of types of stents overlap each other, there is a possibility that corresponding points may not be set with high accuracy even in a case where the mesh-like model is applied.

### SUMMARY OF THE INVENTION

The present disclosure has been made in view of the above circumstances, and an object of the present disclosure is to provide a technique capable of simply and accurately perform registration of a tubular structure such as a stent placed in a blood vessel, which is included in medical images having different imaging times.

According to an aspect of the present disclosure, there is provided a registration apparatus including: a tubular region acquisition unit that acquires a first tubular region and a second tubular region that represent a tubular structure that is a registration target from a first medical image and a second medical image captured at different imaging times, respectively, for a subject including the tubular structure;

a model setting unit that sets a first tubular model and a second tubular model that represent a surface shape of the tubular structure, respectively, for the first tubular region and the second tubular region;

a corresponding point setting unit that sets a plurality of corresponding points that correspond to each other, respectively, for the first tubular model and the second tubular model; and

a first registration unit that registers the first tubular model and the second tubular model on the basis of the corresponding points to acquire a first registration result.

The “tubular model that represents the surface shape of the tubular structure” means a model formed of only a surface that defines the shape of the tubular structure, which does not include an unevenness included in the tubular structure and a hole penetrating a wall surface of the tubular structure. In particular, in a case where the tubular structure has a mesh-like structure such as a stent, a space of the mesh is a hole passing through the wall surface of the tubular structure. For this reason, the tubular model is set by interpolating a space in the outermost contour, the innermost contour, or any contour between the outermost contour and the innermost contour in the tubular structure, using a surface.

In the registration apparatus according to the present disclosure, the first registration unit may acquire the first registration result by non-rigid registration.

Further, in the registration apparatus according to the present disclosure, the first registration result may be the amount of movement and the amount of deformation of one of the first tubular model and the second tubular model with respect to the other.

Further, the registration apparatus according to the present disclosure may further include a second registration unit that registers the first tubular region and the second tubular region on the basis of the first registration result to acquire a second registration result.

In the registration apparatus according to the present disclosure, the second registration unit may acquire the second registration result by non-rigid registration.

Further, in the registration apparatus according to the present disclosure, the second registration result may be the amount of movement and the amount of deformation of one of the first tubular region and the second tubular region with respect to the other.

Further, in the registration apparatus according to the present disclosure, the corresponding point setting unit may set the plurality of corresponding points at equal intervals, respectively, for the first tubular model and the second tubular model.

Further, in the registration apparatus according to the present disclosure, the first and second medical images may include a blood vessel in which a stent is placed, and

the tubular structure may be the stent.

According to another aspect of the present disclosure, there is provided a registration method including: acquiring a first tubular region and a second tubular region that represent a tubular structure that is a registration target from a first medical image and a second medical image captured at different imaging times, respectively, for a subject including the tubular structure;

setting a first tubular model and a second tubular model that represent a surface shape of the tubular structure, respectively, for the first tubular region and the second tubular region;

setting a plurality of corresponding points that correspond to each other, respectively, for the first tubular model and the second tubular model; and

registering the first tubular model and the second tubular model on the basis of the corresponding points to acquire a first registration result.

According to still another aspect of the present disclosure, there is provided a program causing a computer to execute the registration method according to the present disclosure.

According to still another aspect of the present disclosure, there is provided a registration apparatus comprising: a memory that stores a command for execution in a computer; and a processor configured to execute the stored command, wherein the processor executes: a process of acquiring a first tubular region and a second tubular region that represent a tubular structure that is a registration target from a first medical image and a second medical image captured at different imaging times, respectively, for a subject including the tubular structure, a process of setting a first tubular model and a second tubular model that represent a surface shape of the tubular structure, respectively, for the first tubular region and the second tubular region, a process of setting a plurality of corresponding points that correspond to each other, respectively, for the first tubular model and the second tubular model; and a process of registering the first tubular model and the second tubular model on the basis of the corresponding points to acquire a first registration result.

According to the present disclosure, a first tubular region and a second tubular region that represent a tubular structure that is a registration target are acquired from a first medical image and a second medical image captured at different imaging times, respectively, for a subject including the tubular structure, and a first tubular model and a second tubular model that represent a surface shape of the tubular structure are respectively set for the first tubular region and the second tubular region. Further, a plurality of corresponding points that correspond to each other are respectively set for the first tubular model and the second tubular model, and the first tubular model and the second tubular model are registered on the basis of the corresponding points to obtain a first registration result. Accordingly, it is possible to set corresponding points in the first tubular model and the second tubular model without bothering an operator. Further, it is possible to acquire the first registration result with high accuracy on the basis of the set corresponding points.

### BRIEF DESCRIPTION OF THE DRAWINGS

FIG. 1 is a hardware configuration diagram showing an outline of a diagnosis support system to which a registration apparatus according to an embodiment of the present disclosure is applied.

FIG. 2 is a diagram showing a schematic configuration of a registration apparatus.

FIG. 3 is a diagram for illustrating acquisition of a stent region.

FIG. 4 is a diagram for illustrating setting of a tubular model.

FIG. 5 is a diagram showing a cross section orthogonal to a center line of a first stent region.

FIG. 6 is a diagram for illustrating setting of corresponding points.

FIG. 7 is a diagram for illustrating setting of corresponding points.

FIG. 8 is a diagram for illustrating setting of corresponding points in each cross section of a first tubular model.

FIG. 9 is a diagram for illustrating first registration.

FIG. 10 is a diagram for illustrating acquisition of a second registration result.

FIG. 11 is a diagram for illustrating acquisition of a second registration result.

FIG. 12 is a flowchart showing a process performed in the present embodiment.

### DETAILED DESCRIPTION

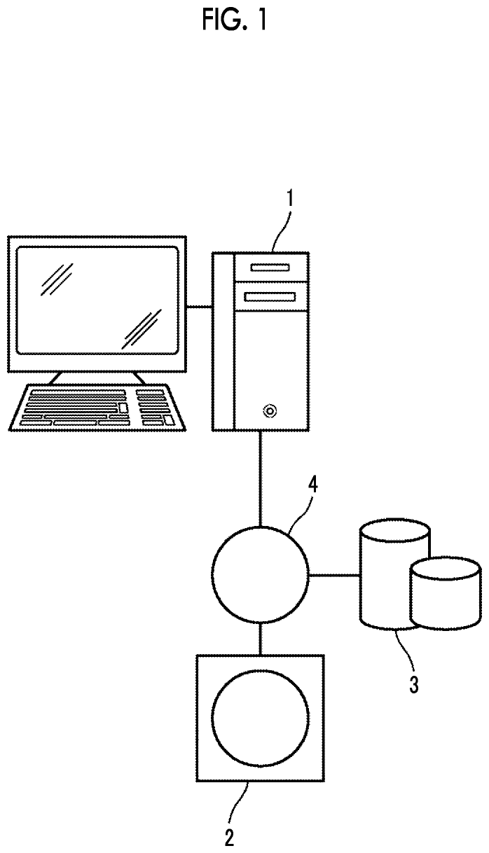

Hereinafter, embodiments of the present disclosure will be described with reference to the accompanying drawings. FIG. 1 is a hardware configuration diagram showing an outline of a diagnosis support system to which a registration apparatus according to an embodiment of the present disclosure is applied. As shown in FIG. 1, in the diagnosis support system, a registration apparatus 1, a three-dimensional image capturing device 2, and an image storage server 3 according to the present embodiment are communicably connected through a network 4. Then, in the diagnosis support system, a process of acquiring two three-dimensional images of a blood vessel such as an aorta in which a stent is placed at different imaging times and detecting deviation of the stent between the two three-dimensional images is performed.

The three-dimensional image capturing device 2 is a device that generates a three-dimensional image that represents a part of a subject to be diagnosed by capturing an image of the part, which is specifically a CT device, a magnetic resonance imaging (MRI) device, a positron emission tomography (PET) device, or the like. The three-dimensional image generated by the three-dimensional image capturing device 2 is transmitted to the image storage server 3 for storage. In the present embodiment, since the registration of the stent between two three-dimensional images is performed by detecting the movement and deformation of the stent placed in the aorta over time, a diagnosis target site of the subject is set to a chest portion including the aorta. Further, it is assumed that the three-dimensional image capturing device 2 is a CT device and generates a three-dimensional image consisting of tomographic images of a plurality of axial sections of the chest portion of the subject. The three-dimensional image corresponds to a medical image.

The image storage server 3 is a computer that stores and manages various data, and includes a large-capacity external storage device and database management software. The image storage server 3 communicates with other devices through a wired or wireless network 4 to transmit and receive image data or the like. Specifically, image data of three-dimensional images generated by the three-dimensional image capturing device 2 is acquired through a network, and is then stored on a recording medium such as a large-capacity external storage device for management. A storage format of the image data and the communication between the devices through the network 4 are based on a protocol such as digital imaging and communication in medicine (DICOM). In the present embodiment, a plurality of three-dimensional images of the same subject captured at different imaging times are stored in the image storage server 3.

The registration apparatus 1 is a single computer, in which a registration program according to the present disclosure is installed. The computer may be a workstation or a personal computer directly operated by a doctor who performs diagnosis, or may be a server computer connected to thereto through a network. The registration program is recorded and distributed on a recording medium such as a digital versatile disc (DVD) or a compact disc read only memory (CD-ROM), and is installed in the computer from the recording medium. Alternatively, the registration program may be stored in a storage device of a server computer connected to a network or a network storage in a state where the registration program is accessible from the outside, and may be downloaded and installed on a computer used by a doctor in response to a request.

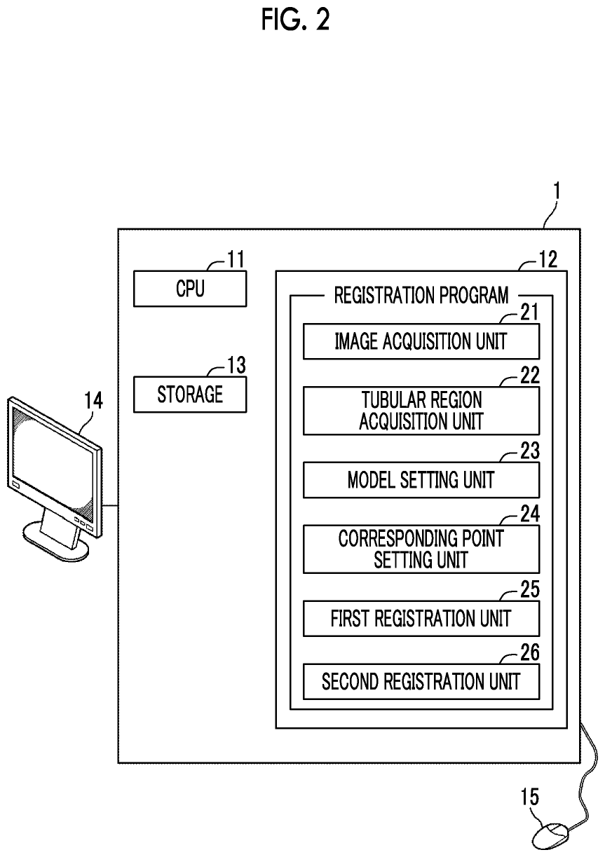

FIG. 2 is a diagram showing a schematic configuration of a registration apparatus realized by installing a registration program on a computer. As shown in FIG. 2, the registration apparatus 1 includes a central processing unit (CPU) 11, a memory 12, and a storage 13, as a standard workstation configuration. Further, a display 14 such as a liquid crystal display and an input unit 15 such as a keyboard and a mouse are connected to the registration apparatus 1.

The storage 13 includes a storage device such as a hard disk or a solid state drive (SSD). The storage 13 stores various types of information including a three-dimensional image of a subject and information necessary for processing, obtained from the image storage server 3 through the network 4.

Further, the memory 12 stores a registration program. The registration program defines, as processes to be executed by the CPU 11, an image acquisition process of acquiring a first three-dimensional image and a second three-dimensional image having different imaging times, and a tubular region acquisition process of acquiring a first stent region (tubular region) and a second stent region that represent a stent (tubular structure) that is a registration target from the first three-dimensional image and the second three-dimensional image having the different imaging times, respectively, for a subject including the tubular structure, a model setting process of setting a first tubular model and a second tubular model that represent a surface shape of the stent for the first stent region and the second stent region, respectively, a corresponding point setting process of setting a plurality of corresponding points that correspond to each other for the first and second tubular models, a first registration process of registering the first tubular model and the second tubular model on the basis of the corresponding points to acquire a first registration result, and a second registration process of registering the first stent region and the second stent region on the basis of the first registration result to acquire a second registration result.

As the CPU 11 executes these processes according to the program, the computer functions as an image acquisition unit 21, a tubular region acquisition unit 22, a model setting unit 23, a corresponding point setting unit 24, a first registration unit 25, and a second registration unit 26. In the present embodiment, the CPU 11 executes the functions of the respective units by the registration program, but as a general-purpose processor that executes software to function as various processing units, a programmable logic device (PLD) that is a processor whose circuit configuration is changeable after manufacturing, such as a field programmable gate array (FPGA), may be used, as well as the CPU 11. Further, the processes of the respective units may be performed by a dedicated electric circuit that is a processor having a circuit configuration dedicatedly designed to execute a specific process, such as an application specific integrated circuit (ASIC).

One processing unit may be configured by one of these various processors, or may be configured by a combination of two or more processors of the same type or different types (for example, a plurality of FPGAs or a combination of a CPU and an FPGA). Further, a plurality of processing units may be configured by one processor. As an example in which a plurality of processing units is configured by one processor, first, as represented by a computer such as a client or a server, there is a form in which one processor is configured by a combination of one or more CPUs and software and the processor functions as a plurality of processing units. Second, as represented by a system-on-chip (SoC), there is a form in which a processor that realizes functions of an entire system including a plurality of processing units by one integrated circuit (IC) chip is used. As described above, the various processing units are configured using one or more of the above various processors as a hardware structure.

Furthermore, a hardware structure of these various processors is more specifically an electric circuitry in which circuit elements such as semiconductor elements are combined.

The image acquisition unit 21 acquires a first three-dimensional image G1 and a second three-dimensional image G2 of the same subject captured at different imaging times from the image storage server 3. In a case where the first and second three-dimensional images G1 and G2 are already stored in the storage 13, the three-dimensional images G1 and G2 may be acquired from the storage 13. In the following description, it is assumed that the imaging time of the first three-dimensional image G1 is earlier than that of the second three-dimensional image G2.

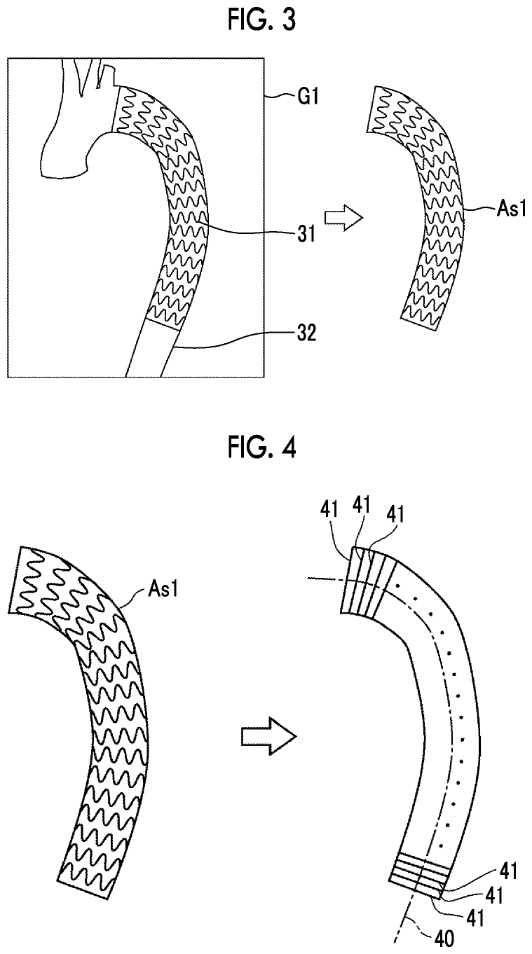

The tubular region acquisition unit 22 acquires a first stent region and a second stent region that represent a stent that is a registration target from the first and second three-dimensional images G1 and G2, respectively. The stent corresponds to the tubular structure, the first stent region corresponds to the first tubular region, and the second stent region corresponds to the second tubular region. FIG. 3 is a diagram for illustrating acquisition of a stent region. Since the acquisition of the stent region is performed by the same process in the first and second three-dimensional images G1 and G2, only the acquisition of the first stent region from the first three-dimensional image G1 will be described hereinafter.

As shown in FIG. 3, the first three-dimensional image G1 includes a blood vessel 32 in which the stent 31 is placed. Since the stent 31 is made of metal, in the first three-dimensional image G1 that is a CT image, a region of the stent 31 has a higher CT value than a tissue of a human body. For this reason, the tubular region acquisition unit 22 acquires a first stent region As1 from the first three-dimensional image G1 by performing a binarization process of extracting a region having a CT value higher than a predetermined threshold value from the first three-dimensional image G1. Further, the tubular region acquisition unit 22 acquires a second stent region As2 from the second three-dimensional image G2.

The model setting unit 23 sets a first tubular model and a second tubular model that represent a surface shape of the stent 31 for the first stent region As1 and the second stent region As2, respectively. Here, since the setting of the tubular model is performed by the same process in the first and second stent regions As1 and As2, only the setting of the first tubular model for the first stent region As1 will be described hereinafter.

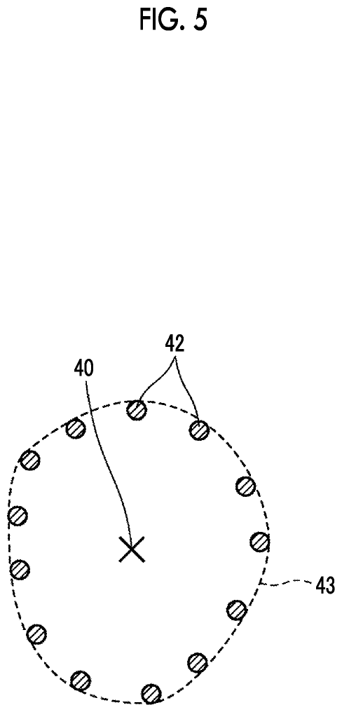

FIG. 4 is a diagram for illustrating setting of a tubular model, and FIG. 5 is a diagram showing a cross section orthogonal to a center line of the first stent region As1. The model setting unit 23 sets a plurality of cross sections 41 orthogonal to the center line 40 at predetermined uniform intervals along the center line 40 with respect to the first stent region As1. Since the stent 31 has a cylindrical shape of a mesh made of metal, in a cross section orthogonal to the center line 40 of the stent region As1, cross sections 42 of metallic members that form the mesh are disposed in parallel in accordance with a cross sectional shape of the blood vessel. The model setting unit 23 sets points that are most distant from the center line 40 of the first stent region As1 with respect to the cross sections 42 of the metallic members included in each cross section 41, and nonlinearly interpolates the set points to form a closed curve 43. The closed curve 43 represents an outer shape of the cross section 41. The model setting unit 23 further nonlinearly interpolates the closed curve 43 in each cross section 41 in a longitudinal direction of the first stent region As1 to form a surface, thereby setting a first tubular model M1. As a nonlinear interpolation method, for example, a method using a function such as a B-spline and a thin plate spline may be used. In addition, the model setting unit 23 sets a second tubular model M2 for the second stent region As2 in the same manner as in the first tubular model M1.

The method of setting of the closed curve 43 is not limited to the method based on the points that are most distant from the center line 40 of the first stent region As1 with respect to the cross sections 42 of the metallic members. For example, the closed curve 43 may be set based on points that are closest to the center line 40 of the first stent region As1 with respect to the cross sections 42 of the metallic members. Further, the closed curve 43 may be set on the basis of predetermined positions between a point that is most distant from the center line 40 of the first stent region As1 and points that are closest to the center line 40 in the metal cross section 42, such as center points of the cross sections 42 of the metallic members, for example.

The corresponding point setting unit 24 sets a plurality of corresponding points that correspond to each other for the first tubular model M1 and the second tubular model M2, respectively. Specifically, the plurality of corresponding points are set at equal intervals for the first tubular model M1 and the second tubular model M2, respectively. Since the setting of the corresponding points is performed by the same process in the first tubular model M1 and the second tubular model M2, only the setting of the corresponding points for the first tubular model M1 will be described hereinafter.

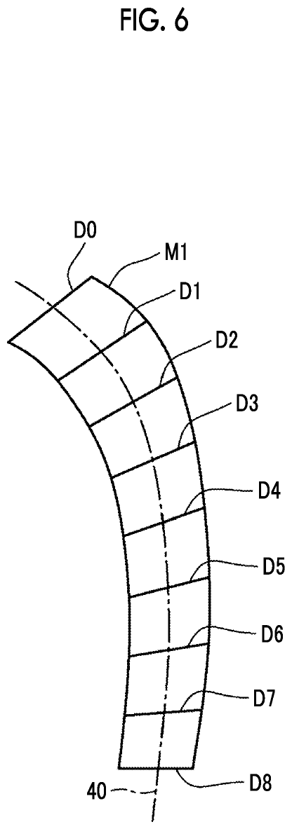

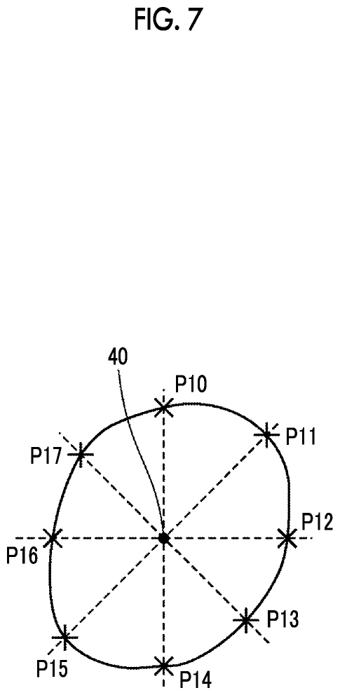

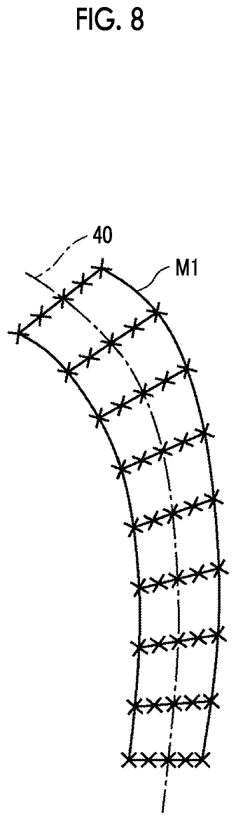

FIGS. 6 and 7 are diagrams for illustrating setting of corresponding points. The corresponding point setting unit 24 equally divides the center line 40 of the first tubular model M1 in the longitudinal direction. The number of equal divisions is eight in this embodiment, but may be less than eight or more than eight. Then, the corresponding point setting unit 24 sets orthogonal cross sections D1 to D7 at the equally divided points on the center line 40. The corresponding point setting unit 24 sets surfaces D0 and D8 at both ends of the first tubular model M1 in addition to the points obtained by equally dividing the center line 40.

Further, the corresponding point setting unit 24 sets, as corresponding points, intersections between line segments that equally divides the angle around the center line 40 and a contour of each of the surfaces D0 to D8, in each of the set surfaces D0 to D8. In the present embodiment, eight intersections between line segments that divide the angle around the center line 40 into eight and the contour of each of the surfaces D0 to D8 are set as corresponding points P10 to P17. In this case, at adjacent corresponding points (for example, corresponding point P10 and corresponding point P11), an angle formed by line segments connecting the corresponding points and the center line 40 is 45 degrees. The corresponding point P10 among the eight corresponding points P10 to P17 is set as a reference point. The reference point P10 is set at a position that faces the most rear side of the human body, in the first tubular model M1. As a result, as shown in FIG. 8, eight corresponding points P10 to P17 are set on each of the surfaces D0 to D8 in the first tubular model M1. Accordingly, total 72 corresponding points are set. In FIG. 8, the corresponding points are indicated by x marks. The corresponding point setting unit 24 sets corresponding points for the second tubular model M2 in the same manner as described above. In the following description, the corresponding points set in the first tubular model M1 will be referred to as corresponding points P1, and the corresponding points set in the second tubular model M2 will be referred to as corresponding points P2.

The first registration unit 25 registers the first tubular model M1 and the second tubular model M2 on the basis of the corresponding points P1 and P2 to acquire a first registration result. In the present embodiment, non-rigid registration is performed between the corresponding points P1 and P2 of the first tubular model M1 and the second tubular model M2, and a deformation vector Vm1 for matching each corresponding point P1 set in the first tubular model M1 and each corresponding point P2 set in the second tubular model M2 is acquired as the first registration result. The deformation vector Vm1 represents the amount of movement and the amount of deformation of the second tubular model M2 with respect to the first tubular model M1. Hereinafter, the registration for acquiring the first registration result is referred to as first registration.

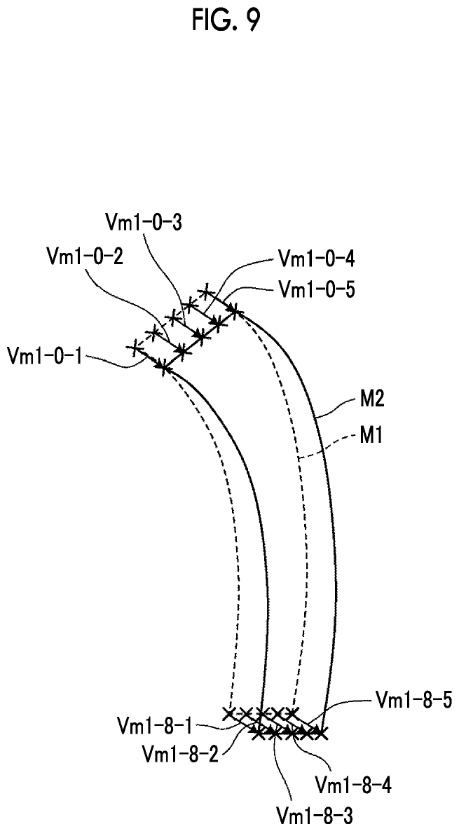

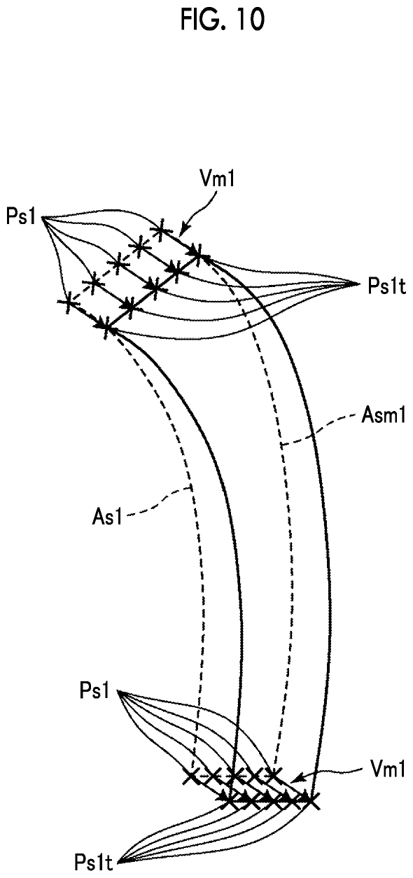

FIG. 9 is a diagram for illustrating the first registration. In FIG. 9, the first tubular model M1 is indicated by a broken line, the second tubular model M2 is indicated by a solid line, and the deformation vector Vm1 is indicated by a solid arrow. For simplicity of description, only the deformation vector Vm1 acquired between the corresponding points P1 and P2 of the plane D0 and the plane D8 in the first tubular model M1 and the second tubular model M2 is shown. In FIG. 9, from the corresponding points P1 on the surface D0 of the first tubular model M1 (only x marks are shown in FIG. 9) to the corresponding points P2 on the surface D0 of the second tubular model M2 (only x marks are shown in FIG. 9), five deformation vectors Vm1-0-1, Vm1-0-2, Vm1-0-3, Vm1-0-4, and Vm1-0-5 between the corresponding points that are visually recognized in a state shown in FIG. 9 are calculated. In addition, from the corresponding points P1 on the surface D8 of the first tubular model M1 (indicated by x marks in a similar way to the corresponding points P1 on the surface D0 in FIG. 9) to the corresponding points P2 on the surface D8 of the second tubular model M2 (indicated by x marks in a similar way to the corresponding points P2 on the surface D0 in FIG. 9), the five deformation vectors Vm1-8-1, Vm1-8-2, Vm1-8-3, Vm1-8-4, and Vm1-8-5 between the corresponding points that are visually recognized in the state shown in FIG. 9 are calculated. Actually, 72 deformation vectors Vm1 are calculated for 72 corresponding points P1 and P2 that are set for each of the first tubular model M1 and the second tubular model M2. Further, by mapping the deformation vector Vm1 to the 72 corresponding points P1 and P2, it is possible to generate a deformation vector map.

As the non-rigid registration, for example, a method of non-linearly converting the corresponding points P1 to the corresponding points P2 using a function such as a B-spline and a thin-plate spline may be used, but the invention is not limited thereto.

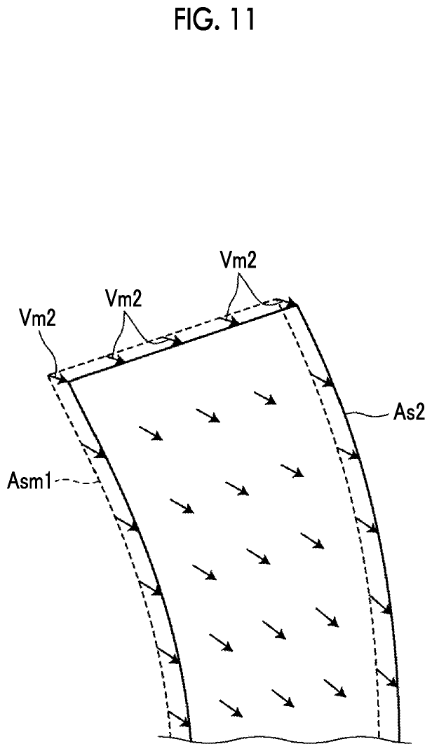

The second registration unit 26 registers the first stent region As1 and the second stent region As2 on the basis of the first registration result to acquire a second registration result. FIGS. 10 and 11 are diagrams for illustrating the acquisition of the second registration result. In the present embodiment, the deformation vector Vm1 at each corresponding point is calculated as the first registration result. Hereinafter, the deformation vector Vm1 is referred to as a first deformation vector Vm1. The second registration unit 26 sets points Psi corresponding to the corresponding points P1 of the first tubular model M1 in the first stent region As1, as shown in FIG. 10. Then, the second registration unit 26 moves the points Psi set in the first stent region As1 on the basis of the first deformation vector Vm1, and calculates a point Ps1t after movement. In a case where the first stent region As1 is deformed on the basis of the first deformation vector Vm1, a first stent region Asm1 after deformation can be acquired as shown in FIG. 10.

Subsequently, the second registration unit 26 performs non-rigid registration so that the first stent region Asm1 after deformation matches the second stent region As2, and calculates a deformation vector for matching each pixel position (voxel position) in the first stent region Asm1 after deformation with a corresponding pixel position in the second stent region As2 as a second deformation vector Vm2.

As the non-rigid registration, for example, using a function such as a B-spline and a thin plate spline (Thin Plate Spline), a method for non-linearly converting each pixel position in the first stent region Asm1 after deformation into the corresponding pixel position in the second stent region As2 so that evaluation values such as mutual information amounts of each pixel position in the first stent region Asm1 after deformation and the corresponding pixel position in the second stent region As2 is optimized may be used, but the invention is not limited thereto.

FIG. 11 is a diagram for illustrating the acquisition of the second registration result. In FIG. 2, the first stent region Asm1 after deformation is indicated by a broken line, the second stent region As2 is indicated by a solid line, and the second deformation vector Vm2 is indicated by a solid line arrow. In addition, actually, the second deformation vector Vm2 is obtained for all the pixel positions in the first stent region Asm1 after deformation and second stent region As2, but for simplicity of description in FIG. 1, only the second deformation vector Vm2 for some pixel positions in the first stent region Asm1 after deformation and second stent region As2 is shown.

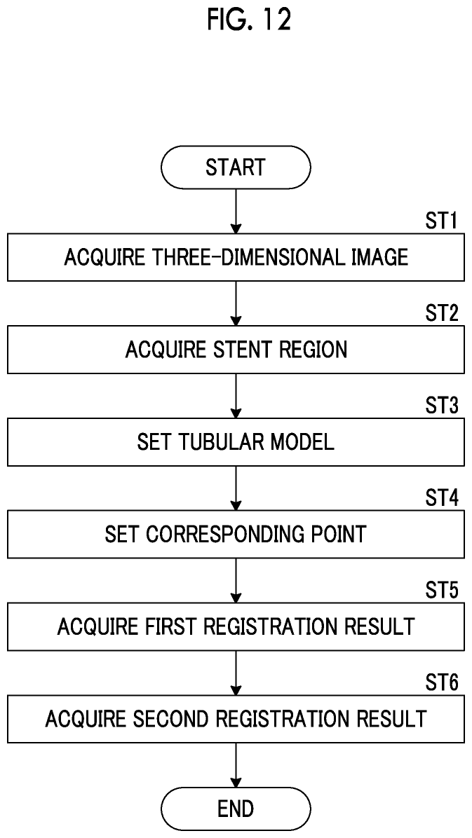

Next, a process performed in the present embodiment will be described. FIG. 12 is a flowchart showing a process performed in the present embodiment. First, the image acquisition unit 21 acquires the three-dimensional images G1 and G2 (step ST1), and the tubular region acquisition unit 22 acquires the first stent region As1 and the second stent region As2 from the three-dimensional images G1 and G2, respectively (step ST2). Then, the model setting unit 23 sets the first tubular model M1 and the second tubular model M1 that represent the surface shape of the stent 31, respectively, for the first stent region As1 and the second stent region As2 (step ST3).

Then, the corresponding point setting unit 24 sets the plurality of corresponding points P1 and P2 that correspond to each other, respectively, for the first tubular model M1 and the second tubular model M2 (step ST4). Then, the first registration unit 25 registers the first tubular model M1 and the second tubular model M2 on the basis of the corresponding points P1 and P2 to acquire a first registration result (step ST5). Further, the second registration unit 26 registers the first stent region As1 and the second stent region As2 on the basis of the first registration result to obtain a second registration result (step ST6), and the process ends.

As described above, in the present embodiment, the first stent region As1 and the second stent region As2 that represent the stent 31 that is a registration target are respectively acquired from the first three-dimensional image G1 and the second three-dimensional image G2 captured at different imaging times for the subject including the stent 31, and the first tubular model M1 and the second tubular model M2 that represent the surface shape of the stent 31 are respectively set for the first stent region As1 and the second stent region As2. Then, the plurality of corresponding points P1 and P2 that correspond to each other are respectively set for the first tubular model M1 and the second tubular model M2, and the first tubular model M1 and the second tubular model M2 are registered on the basis of the corresponding points P1 and P2 to acquire the first registration result. Accordingly, it is possible to set the corresponding points in the first tubular model M1 and the second tubular model M2 without bothering an operator. Further, it is possible to acquire the first registration result with high accuracy on the basis of the set corresponding points P1 and P2.

In particular, in the present embodiment, since the tubular structure is the stent 31, by using the first tubular model M1 and the second tubular model M2, it is not necessary to prepare a plurality of models according to the type of the stent 31. Further, it is not necessary to use parameters for correcting the shape and size of the mesh based on the deformation of the stent 31. Accordingly, it is possible to easily and accurately perform the registration of the first tubular model M1 and the second tubular model M2.

Further, since the first tubular region and the second tubular region are registered on the basis of the first registration result to acquire the second registration result, it is possible to register the first stent region As1 and the second stent region As2 with a smaller amount of calculation.

In the above-described embodiment, as the first registration result, the amount of movement and the amount of deformation of the second tubular model M2 with respect to the first tubular model M1 are calculated as the first deformation vector Vm1, but the present invention is not limited thereto. As the first registration result, the amount of movement and the amount of deformation of the first tubular model M1 with respect to the second tubular model M2 may be calculated as the first deformation vector Vm1.

Further, in the above embodiment, as the second registration result, the amount of movement and the amount of deformation of the second stent region As2 with respect to the deformed first stent region Asm1 are calculated as the second deformation vector Vm2, but the present invention is not limited thereto. As the second registration result, the amount of movement and the amount of deformation of the first stent region Asm1 after the deformation with respect to the second stent region As2 may be calculated as the second deformation vector Vm2.

Further, in the above embodiment, the registration result between the first three-dimensional image G1 and the second three-dimensional image G2 for the stent 31 placed in the aorta is acquired, but instead of the aorta, any blood vessel in which it is necessary to place a stent may be used. For example, the present embodiment may be similarly applied in performing registration of a stent placed in a coronary artery, a cerebral artery, or the like.

In the above embodiment, a CT image is used as a medical image, but the present invention is not limited thereto, and an MRI image, a PET image, or the like may be used as a medical image.

In the above embodiment, the corresponding points P1 and P2 are set at equal intervals for the first tubular model M1 and the second tubular model M2, but the present invention is not limited to thereto. As long as the positions correspond to each other between the first tubular model M1 and the second tubular model M2, the corresponding points P1 and P2 may be set at random intervals.

Hereinafter, an operation and effects of the present embodiment will be described.

In a case where the tubular structure is a stent, by using the first tubular model and the second tubular model, it is not necessary to prepare a plurality of models according to the type of the stent. Further, it is not necessary to use parameters for correcting the shape and size of a mesh based on deformation of the stent. Accordingly, it is possible to easily and accurately perform registration of the first tubular model and the second tubular model.

In addition, it is possible to register the first tubular region and the second tubular region with a smaller amount of calculation by registering the first tubular region and the second tubular region on the basis of the first registration result to acquire the second registration result.

What is claimed is:

1. A registration apparatus comprising at least one processor, wherein the processor is configured to:
acquire a first tubular region and a second tubular region that represent a tubular structure that is a registration target from a first medical image and a second medical image captured at different imaging times, respectively, for a subject including the tubular structure;
set a first tubular model and a second tubular model that represent a surface shape of the tubular structure, respectively, for the first tubular region and the second tubular region;
set a plurality of corresponding points that correspond to each other, respectively, for the first tubular model and the second tubular model; and
register the first tubular model and the second tubular model on the basis of the corresponding points to acquire a first registration result.

2. The registration apparatus according to claim 1,
wherein the processor is configured to acquire the first registration result by non-rigid registration.

3. The registration apparatus according to claim 1,
wherein the first registration result is an amount of movement and an amount of deformation of one of the first tubular model and the second tubular model with respect to the other.

4. The registration apparatus according to claim 1,
wherein the processor is configured to register the first tubular region and the second tubular region on the basis of the first registration result to obtain a second registration result.

5. The registration apparatus according to claim 4,
wherein the processor is configured to acquire the second registration result by non-rigid registration.

6. The registration apparatus according to claim 4,
wherein the second registration result is the amount of movement and the amount of deformation of one of the first tubular region and the second tubular region with respect to the other.

7. The registration apparatus according to claim 1,
wherein the processor is configured to set the plurality of corresponding points at equal intervals, respectively, for the first tubular model and the second tubular model.

8. The registration apparatus according to claim 1,
wherein the first and second medical images include a blood vessel in which a stent is placed, and
wherein the tubular structure is the stent.

9. A registration method comprising:
acquiring a first tubular region and a second tubular region that represent a tubular structure that is a registration target from a first medical image and a second medical image captured at different imaging times, respectively, for a subject including the tubular structure;
setting a first tubular model and a second tubular model that represent a surface shape of the tubular structure, respectively, for the first tubular region and the second tubular region;
setting a plurality of corresponding points that correspond to each other, respectively, for the first tubular model and the second tubular model; and
registering the first tubular model and the second tubular model on the basis of the corresponding points to obtain a first registration result.

10. A non-transitory computer-readable storage medium that stores a registration program causing a computer to execute:
a step of acquiring a first tubular region and a second tubular region that represent a tubular structure that is a registration target from a first medical image and a second medical image captured at different imaging times, respectively, for a subject including the tubular structure;
a step of setting a first tubular model and a second tubular model that represent a surface shape of the tubular structure, respectively, for the first tubular region and the second tubular region;
a step of setting a plurality of corresponding points that correspond to each other, respectively, for the first tubular model and the second tubular model; and
a step of registering the first tubular model and the second tubular model on the basis of the corresponding points to obtain a first registration result.
